(19) United States
(12) Patent Application Publication
(10) Pub. No.: US 2024/0281855 A1
(43) Pub. Date: Aug. 22, 2024

(54) METHOD AND SYSTEM FOR PROVIDING KEYWORD REVIEWS

(71) Applicant: NAVER CORPORATION, Seongnam-si (KR)

(72) Inventors: Keonsu LEE, Seongnam-si (KR); Yungseong LEE, Seongnam-si (KR); Jisu KIM, Seongnam-si (KR); Mi Ju PARK, Seongnam-si (KR); Kyungil KIM, Seongnam-si (KR); Youngmi BAEK, Seongnam-si (KR); Insung KANG, Seongnam-si (KR); You Jin SHIN, Seongnam-si (KR); Jiwon PARK, Seongnam-si (KR); Yejin KIM, Seongnam-si (KR); Joo Youl LIM, Seongnam-si (KR); Selin HA, Seongnam-si (KR); Bo Eun PARK, Seongnam-si (KR)

(21) Appl. No.: 18/653,424

(22) Filed: May 2, 2024

Related U.S. Application Data
(63) Continuation of application No. PCT/KR2022/003386, filed on Mar. 10, 2022.

(30) Foreign Application Priority Data
Nov. 5, 2021 (KR) 10 2021 0151629

(51) Int. Cl. G06Q 30/0282

(52) U.S. Cl. CPC G06Q 30/0282

(57) ABSTRACT

A keyword review method includes registering, as a keyword list related to a place, at least one of a word, a phrase, or a sentence describing a feature of the place; and registering, as a review of the place, at least one keyword selected from the keyword list by providing the keyword list to users who have visited or used the place.

### CROSS-REFERENCE TO RELATED APPLICATION(S)

This is a continuation application of International Application No. PCT/KR2022/003386, filed Mar. 10, 2022, which claims the benefit of priority of Korean Patent Application No. 10-2021-0151629 filed Nov. 5, 2021.

### BACKGROUND OF THE INVENTION

### Field of the Invention

The following description relates to improving a system for reviewing a place.

### Description of Related Art

An evaluation system using star ratings is being used as an example of a user review for a place. For example, Korean Patent Laid-Open Publication No. 10-2020-0000925 (published on Jan. 6, 2020) describes technology for generating review information of a store using augmented reality.

A place review service may authenticate a place visited or used by a user using a place reservation function, a receipt authentication function, etc., and then, may submit information on the authenticated place with a review.

A user review for a place may be exposed in conjunction with other services that provide place information, such as a search service or a map service as well as a place review service. In the case of reviews using star ratings, scores left by users who have visited or used a corresponding place may be averaged and displayed.

In the case of such reviews using star ratings, a person involved in operating a corresponding place (business owner, etc.) may have difficulty due to the structure in which the place is evaluated based on scores given by users, and there is an issue that low star ratings of some users have a significant impact on the overall average of the scores.

On a user side, there is a convenience of being able to simply filtering through reviews using star ratings, but there is a distortion in reviews since it is difficult to reflect individual taste.

### BRIEF SUMMARY OF THE INVENTION

An example embodiment may provide a keyword review as a new review system capable of replacing a review using star ratings.

An example embodiment may replace a one-sided review environment centered on star ratings with a review environment capable of expressing qualitative information on a place.

An example embodiment may provide a review method that selects a keyword close to user experience based on visit or use from among keywords representing features of a corresponding place.

According to an example embodiment, there is provided a keyword review method executed by a computer system, wherein the computer system includes at least one processor configured to execute computer-readable instructions included in a memory, and the keyword review method includes registering, by the at least one processor, at least one of a word, a phrase, and a sentence representing features of a place as a keyword list related to the place; and providing, by the at least one processor, the keyword list to a user who has visited or used the place and registering at least one keyword selected from the keyword list as a review for the place.

According to an aspect of an embodiment, the registering as the keyword list related to the place may include building a candidate keyword pool related to each business type by business type; and providing the candidate keyword pool corresponding to a business type of the place to an interested party of the place and registering at least one keyword selected from the candidate keyword pool as the keyword list.

According to another aspect, the registering as the keyword list related to the place may include extracting a keyword related to the place in a form of at least one of a word, a phrase, and a sentence, from at least one of a document, search log data, and a text review on the Internet related to the place.

According to still another aspect, the registering as the keyword list related to the place may include extracting a keyword related to the place from a word dictionary that includes a word or a hashtag appearing in a document on the Internet in which the place is mentioned.

According to still another aspect, the registering as the keyword list related to the place may include extracting a keyword related to the place from a text review of the place based on feedback of other users on the text review of the place.

According to still another aspect, the registering as the keyword list related to the place may include extracting the keyword related to the place through learning using an artificial intelligence (AI) model for a keyword on a document related to the place.

According to still another aspect, the registering as the keyword list related to the place may include excluding at least one of a keyword representing factual information and a keyword having negative connotation from the candidate keyword pool.

According to still another aspect, the registering as the review for the place may include registering a review using the keyword list within a certain number of times based on a business type or a region of the place by user.

According to still another aspect, the keyword review method may further include visualizing, by the at least one processor, and providing keyword statistics on keywords registered as the review for the place.

According to still another aspect, the visualizing and providing of the keyword statistics may include providing the keyword statistics by at least one criterion among unit period, gender, age, and region.

According to still another aspect, the keyword review method may further include providing, by the at least one processor, at least one keyword registered as the review for the place as a search filter for place search.

According to an example embodiment, there is provided a non-transitory computer-readable storage medium for storing a computer program to computer-implement the keyword review method.

According to an example embodiment, there is provided a computer system including at least one processor configured to execute computer-readable instructions included in a memory, wherein the at least one processor is configured to process registering at least one of a word, a phrase, and a sentence representing features of a place as a keyword list related to the place; and providing the keyword list to a user who has visited or used the place and registering at least one keyword selected from the keyword list as a review for the place.

According to example embodiments, it is possible to replace a one-sided review environment centered on star ratings with a review environment capable of expressing qualitative information on a place by providing a review method that selects a keyword close to user experience based on a visit or use from among keywords representing features of the corresponding place.

### BRIEF DESCRIPTION OF DRAWINGS

FIG. 1 is a diagram illustrating an example of a network environment according to an example embodiment.

FIG. 2 is a block diagram illustrating an example of a computer system according to an example embodiment.

FIG. 3 is a diagram illustrating an example of a component includable in a processor of a computer system according to an example embodiment.

FIG. 4 is a flowchart illustrating an example of a method performed by a computer system according to an example embodiment.

FIG. 5 is a diagram illustrating an example of a process of selecting a review keyword list according to an example embodiment.

FIGS. 6 and 7 are diagrams illustrating examples of a process of registering a keyword review according to an example embodiment.

FIGS. 8A and 8B are diagrams illustrating examples of a process of providing keyword statistics according to an example embodiment.

FIGS. 9 and 10 are diagrams illustrating examples of a place search process using a review keyword according to an example embodiment.

### DETAILED DESCRIPTION OF THE INVENTION

Hereinafter, some example embodiments will be described with reference to the accompanying drawings.

Example embodiments relate to technology that may improve a system for reviewing a place.

Example embodiments including those specifically disclosed herein may provide a keyword review capable of intuitively verifying features of a place as a new review system capable of replacing a review using star ratings.

Herein, the term “place” may refer to all objects capable of being reviewed based on user experience gained during a visit or use of the object, such as a restaurant, a store, attractions, a popular place, and the like. Reviews for a corresponding place may include reviews of the user experience offline and online.

A keyword review system according to the example embodiments may be implemented by at least one computer system and a keyword review method according to the example embodiments may be performed by at least one computer system included in the keyword review system. Here, a computer program according to an example embodiment may be installed and executed on the computer system, and the computer system may perform the keyword review method according to the example embodiments under the control of the executed computer program. The aforementioned computer program may be stored in a computer-readable storage medium to computer-implement the keyword review method in conjunction with the computer system.

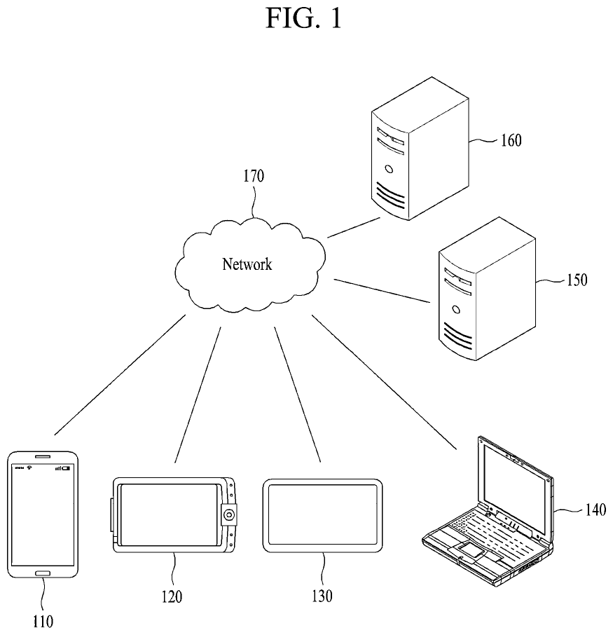

FIG. 1 illustrates an example of a network environment according to an example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as an example only among environments applicable to the example embodiments and the environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140 and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network) includable in the network 170. For example, the network 170 may include at least one network among networks that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected through the network 170 and the server 160 may be a system that provides a second service to the plurality of electronic devices 110, 120, 130, and 140 connected through the network 170. As a specific example, the server 150 may provide a service (e.g., a place review service) desired by a corresponding application to the plurality of electronic devices 110, 120, 130, and 140 through the application of the computer program that is installed and executed on the plurality of electronic devices 110, 120, 130, and 140. As another example, the server 160 may provide a service that distributes a file for installing and executing the application to the plurality of electronic devices 110, 120, 130, and 140 as the second service.

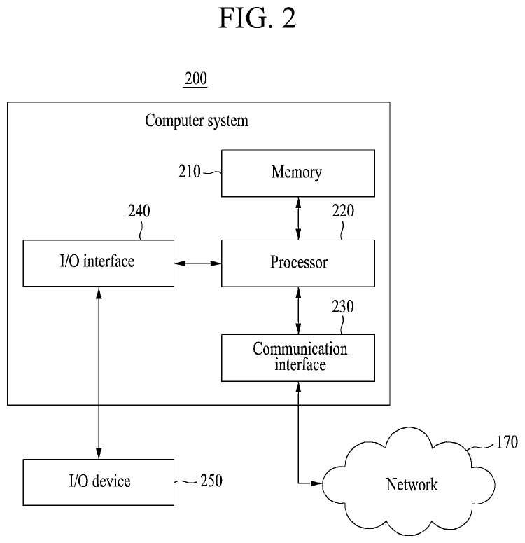

FIG. 2 is a block diagram illustrating an example of a computer system according to an example embodiment. Each of the plurality of electronic devices 110, 120, 130, and 140 or each of the servers 150 and 160 described above may be implemented by a computer system 200 of FIG. 2.

Referring to FIG. 2, the computer system 200 may include a memory 210, a processor 220, a communication interface 230, and an input/output (I/O) interface 240.

The memory 210 may include a permanent mass storage device, such as a random access memory (RAM), a read only memory (ROM), and a disk drive, as a computer-readable recording medium. A permanent mass storage device, such as ROM and a disk drive, may be included in the computer system 200 as a permanent storage device separate from the memory 210. Also, an OS and at least one program code may be stored in the memory 210. Such software components may be loaded to the memory 210 from another computer-readable recording medium separate from the memory 210. The other computer-readable recording medium may include a computer-readable recording medium, for example, a floppy drive, a disk, a tape, a DVD/CD-ROM drive, a memory card, etc. According to other example embodiments, software components may be loaded to the memory 210 through the communication interface 230, instead of the computer-readable recording medium. For example, the software components may be loaded to the memory 210 of the computer system 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication system 200 and another apparatus (e.g., the aforementioned storage devices) over the network 170. For example, the processor 220 of the computer system 200 may deliver a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer system 200 through the network 170 and the communication interface 230 of the computer system 200. For example, a signal, an instruction, data, etc., received through the communication interface 230 may be delivered to the processor 220 or the memory 210, and a file, etc., may be stored in a storage medium (e.g., the permanent storage device) further includable in the computer system 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer system 200.

Also, according to other example embodiments, the computer system 200 may include greater or less number of components than those shown in FIG. 2. For example, the computer system 200 may include at least a portion of the I/O device 250, or may further include other components, such as a transceiver, a database, etc.

Hereinafter, specific example embodiments of a method and a system for a keyword review that may replace star ratings are described.

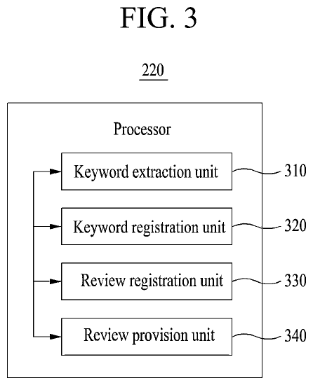

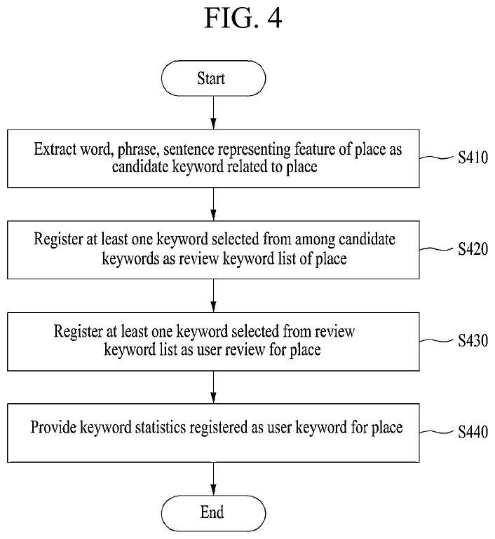

FIG. 3 is a diagram illustrating an example of a component includable in a processor of a computer system according to an example embodiment, and FIG. 4 is a flowchart illustrating an example of a method for providing a keyword review performed by a computer system according to an example embodiment.

The computer system 200 according to the example embodiment may provide a place review service to a client through a dedicated application installed on the client or access to a web/mobile site related to the computer system 200.

Referring to FIG. 3, the processor 220 of the computer system 200 may include a keyword extraction unit 310, a keyword registration unit 320, a review registration unit 330, and a review provision unit 340, as components to perform a keyword review method to be described below. Depending on example embodiments, the components of the processor 220 may be selectively included in or excluded from the processor 220. Also, depending on example embodiments, the components of the processor 220 may be separated or merged for functional expression of the processor 220.

The processor 220 and the components of the processor 220 may control the computer system 200 to perform operations included in the keyword review method to be described below. For example, the processor 220 and the components of the processor 220 may be implemented to execute an instruction according to a code of at least one program and a code of an operating system (OS) included in the memory 210.

Here, the components of the processor 220 may be expressions of different functions performed by the processor 220 in response to an instruction provided from a program code stored in the computer system 200. For example, the keyword extraction unit 310 may be used as a functional expression of the processor 220 that controls the computer system 200 to extract a place-related keyword in response to the instruction.

The processor 220 may read a necessary instruction from the memory 210 to which instructions related to control of the computer system 200 are loaded. In this case, the read instruction may include an instruction for controlling the processor 220 to execute the keyword review method to be described below.

Operations included in the keyword review method to be described below may be performed in order different from illustrated order and some of operations may be omitted or an additional process may be further included.

Referring to FIG. 4, in operation S410, the keyword extraction unit 310 may extract a candidate keyword related to a corresponding place as a keyword representing qualitative information of the place. The keyword extraction unit 310 may build a candidate keyword pool by extracting a word, a phrase, and a sentence representing features of the place. To use collective intelligence to help users discover a place worth visiting, the keyword extraction unit 310 may build the candidate keyword pool by collecting features of places users usually desire to go by business types.

For example, the keyword extraction unit 310 may extract a word, a phrase, or a sentence representing features of each business type as a candidate keyword of a corresponding place, from a document (e.g., post), search log data, and a text review registered as a user review, on the Internet related to the place. The keyword extraction unit 310 may extract a word, a phrase, or a sentence input with at least one keyword of a region name and a business name from a search keyword. For example, the keyword extraction unit 310 may extract “cost effectiveness” from search keyword <Gangnam restaurant cost-effectiveness>as a candidate keyword. The keyword extraction unit 310 may extract a tag frequently used in a post, such as a community timeline or a blog (e.g., restaurant with good view, healthy food, free bread, vegetarian, gluten-free, etc.) or may extract a word, a phrase, or a sentence frequently appearing in text reviews created by users (e.g., the owner is friendly, the bathroom is clean, the atmosphere is good, the photos come out well, etc.).

As another example, the keyword extraction unit 310 may extract a candidate keyword of a corresponding place using a word dictionary that lists theme keywords of places. Words or hashtags appearing in documents on the Internet in which the corresponding place is mentioned as a theme keyword of each place may be listed in the word dictionary. Here, the keyword extraction unit 310 may generate a candidate keyword pool by business type using the word dictionary.

As another example, the keyword extraction unit 310 may extract a candidate keyword based on feedback of users who have visited or used a corresponding place on a text review for the place. For example, the keyword extraction unit 310 may extract a candidate keyword of a corresponding place from a review with high agreement from a subsequent user among previous user reviews by providing a voting right for a review of a user who has previously visited or used the place to a user who has subsequently visited or used the place and by using voting results as a tip.

As another example, the keyword extraction unit 310 may extract place-level keywords through an artificial intelligence (AI) model and may generate the candidate keyword pool. The keyword extraction unit 310 may extract words, phrases, and sentences appropriate for individual places beyond business type-specific keywords through learning using the AI model for keywords on documents related to places. The scope of documents used for keyword learning may include a place review service homepage, a location detail page, a business operator detail page, a visitor review, documents from other linked services, etc.

The keyword extraction unit 310 may refine the candidate keyword pool by excluding a keyword corresponding to factual information, such as the location or the business hours of a place, a menu, etc., and a keyword containing negative connotation from the candidate keyword pool, and by leaving a keyword corresponding to an opinion or evaluation information. Depending on example embodiments, a keyword corresponding to factual information included in the candidate keyword pool may be changed with a keyword used in a review. For example, factual information indicating that there is a parking area may be changed with a review keyword such as “Parking area is large and I like it.” Also, the keyword extraction unit 310 may conduct a vote on at least one of a business operator and a general user in a corresponding business type for the candidate keyword pool and may refine the candidate keyword pool based on voting results.

The keyword extraction unit 310 may classify keywords included in the candidate keyword pool of each business type into at least two topics by business type. For example, in the case of restaurant as a business type, candidate keywords may be classified into three topics, food/price, atmosphere, and convenient facility.

Therefore, the example embodiments have advantage that anybody may understand candidate keywords at a glance by selecting and using a candidate keyword representing features of a place as a descriptive phrase or sentence as well as a word.

In operation S420, the keyword registration unit 320 may register at least one keyword selected from the candidate keyword pool by place as a review keyword list for review registration of the corresponding place. For example, the keyword registration unit 320 may provide a candidate keyword pool corresponding to a business type of a corresponding place to a business operator of each place and may register a keyword selected by the business operator from the candidate keyword pool as a review keyword list for the place of the business operator. The business operator of each place may select m number of keywords for each of n number topic groups from the candidate keyword pool and may register the same as the review keyword list. The review keyword list may be determined by a direct selection of the business operator and, in addition thereto, the review keyword list may be determined using a keyword selected internally by the keyword registration unit 320 based on information related to the corresponding place. For example, a review keyword list may be automatically determined based on a keyword frequently entered by users for hashtags or text reviews in relation to a place.

Limiting the number of keywords is to allow clear comparison with other places and features by converging to a certain number of keywords through the appropriate range selectable as a review for a corresponding place.

Depending on example embodiments, a keyword directly selected by a business operator as well as keywords included in the candidate keyword pool may also be included in the review keyword list.

In operation S430, the review registration unit 330 may provide the review keyword list such that a user who has visited or used the place may leave a keyword review for the place and may register at least one keyword selected by the user from the review keyword list as a user review for the corresponding place. The review registration unit 330 may register a keyword review for the corresponding place through user feedback on a keyword that represents features of the place. The number of keyword review registrations per user may be at least one and may be determined based on a business type or a region of a place to be reviewed. That is, the user may register a keyword review for the place within a preset number of times based on the business type or the region of the place. The keyword review registration method may include a method of providing a topic-by-topic review keyword list in a form of a parallel list to a user who has visited or used the place and enabling the user to select at least one keyword, and a method of sequentially providing keywords with opposing characteristics in pairs to a user who has visited or used the place and enabling the user to select one of two in turn, and the like.

In operation S440, the review provision unit 340 may provide keyword statistics on keywords registered as user reviews for the corresponding place as user feedback results on keywords representing features of the place. That is, the review provision unit 340 may display statistical information on keywords selected by users who have visited or used the place. For example, the review provision unit 340 may display a keyword with a greater number of selections in a larger size in the review keyword list of the corresponding place such that features of the place may be verified at a glance. Here, the review provision unit 340 may display the number of selections for each keyword through simple accumulation or indexing.

The review provision unit 340 may display the keyword statistics divided by unit period (e.g., 6 months, 1 year, etc.). Also, the review provision unit 340 may display the keyword statistics divided by various criteria, such as gender, age, and region. Also, the review provision unit 340 may display the keyword statistics based on a specific period to show keywords that have risen rapidly in rankings and keywords that have newly appeared in rankings. In addition, in relation to the keyword statistics for the place, the review provision unit 340 may provide results of comparing the keyword statistics with other places of the same business type or surrounding commercial district.

When searching for a place, the review provision unit 340 may provide keywords representing features of the place to be searched as a search filter and may include the keywords in search results, and provide places in which keywords corresponding to the search filter are registered as user reviews. Here, the review provision unit 340 may display a place in which a keyword corresponding to the search filter is frequently registered as user reviews at the top of the search results. In addition to the simple number of registrations, the review provision unit 340 may display a place with a high ratio compared to the number of review registrations, such as a place that is rapidly rising in popularity, at the top of the search results.

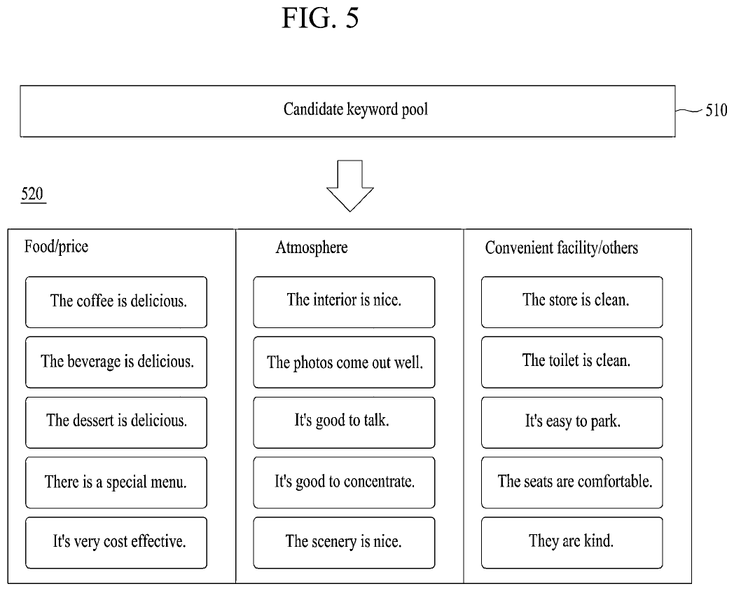

FIG. 5 illustrates a process of selecting a review keyword list according to an example embodiment.

Referring to FIG. 5, the keyword registration unit 320 may provide a candidate keyword pool 510 according to a business type of a corresponding business operator to the business operator. The business operator may select, from the candidate keyword pool 510, keywords suitable for a place corresponding to the business operator's business and well representing features of the place and may register a review keyword list 520 that may be voted on from users in a form of reviews.

The candidate keyword pool 510 may be classified into at least two topic groups by business types and the business operator may select at least one keyword for each topic group from the candidate keyword pool 510 and may register the same as the review keyword list 520.

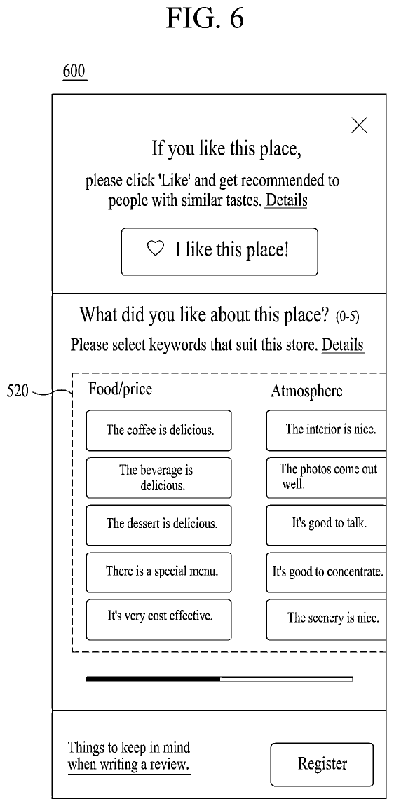

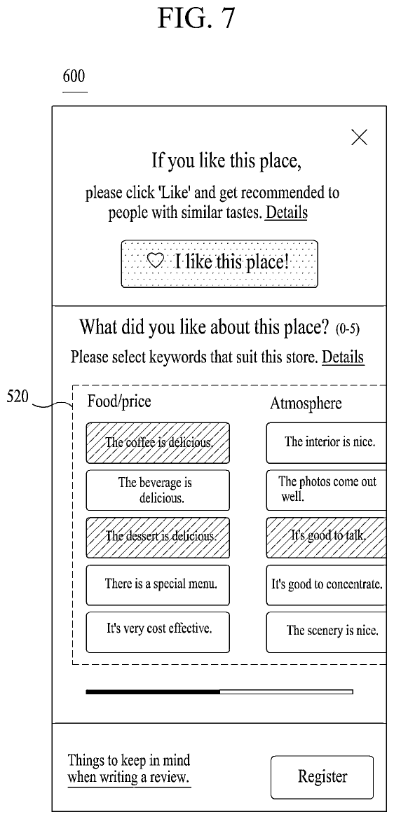

FIGS. 6 and 7 illustrate a process of registering a keyword review according to an example embodiment.

The review registration unit 330 may provide a place reservation function, a receipt authentication function, etc., through a place review service platform and, through this, may authenticate a place visited or used by a user and then match and register a review written by the user with information on the authenticated place.

Referring to FIG. 6, the review registration unit 330 may provide a review writing screen 600 on the electronic devices 110, 120 130, 140 for a specific place to a user who has visited or used the specific place. Here, the review keyword list 520 registered by a business operator of the corresponding place may be displayed on the review writing screen 600.

Here, in addition to a method of displaying topic groups included in the review keyword list 520 and keywords included in each topic group in fixed order, a random rolling method may be applied to the review writing screen 600. Also, keywords for each topic group may be displayed according to scrolling on the review writing screen 600.

An interface for user feedback on the review keyword list 520 may be included in the review writing screen 600. For example, as an interface for entering that there is no keyword to select as a review in the review keyword list 520, an interface that allows a user to directly enter user opinion about the review keyword list 520 and other keywords to suggest in addition to the review keyword list 520 may be provided.

The review registration unit 330 may provide the review keyword list 520 selected by the business operator of the corresponding place through the review writing screen 600 for keyword reviews capable of replacing reviews using star ratings as user reviews for the specific place.

Referring to FIG. 7, a user may find a keyword close to the user's experience according to a visit to the place or a use of the place and may select at least one by topic from the review keyword list 520. The review registration unit 330 may register at least one keyword selected by the user from the review keyword list 520 and may register the same as a keyword review of the user for the corresponding place. The review registration unit 330 may simply accumulate or index the number of selections by keyword registered as a review for each place.

The review writing screen 600 may include an interface for entering a reaction “like,” an interface for entering star ratings, and an interface for writing a photo review or a text review with a keyword review for a corresponding place.

Depending on example embodiments, as keyword reviews replace star ratings, an interface for reviews using star ratings may be omitted from the review writing screen 600.

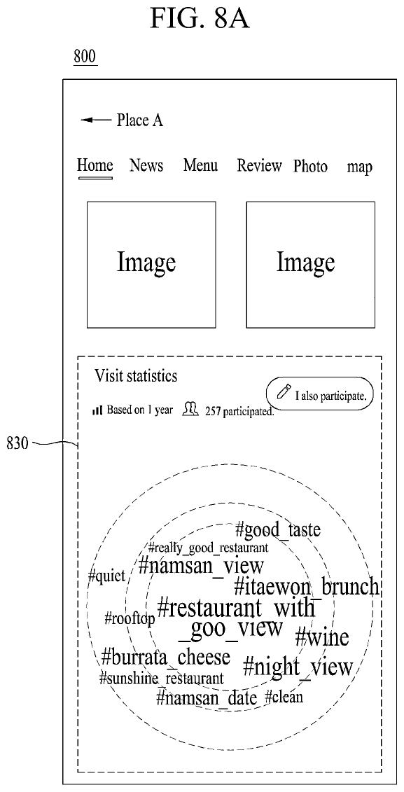

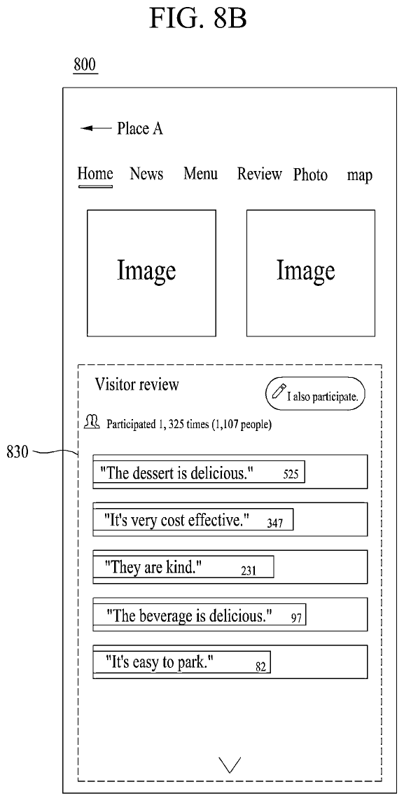

FIGS. 8A and 8B illustrate a process of providing keyword statistics according to an example embodiment.

Referring to FIGS. 8A and 8B, the review provision unit 340 may provide a place information screen 800 including information on a specific place in response to a user request. The review provision unit 340 may visualize and display keyword statistics 830 of keywords registered as user reviews on the place information screen 800 to make it possible to verify features of a corresponding place at a glance. As shown in FIG. 8A, the processor 220 may visualize the keyword statistics 830 through a statistical graph that displays a keyword with a large number of review registrations in larger letters. As shown in FIG. 8B, the processor 220 may visualize the keyword statistics 830 by displaying the number of review registrations for each keyword as a bar graph. In addition, the review provision unit 340 may visualize the keyword statistics 830 using various types of graphs, such as a circle graph, a strip graph, and a broken-line graph. All keywords included in the review keyword list 520 may be included in the keyword statistics 830. Here, a keyword with greater frequency as a keyword review may be displayed in a more discriminable form, for example, in a form in which a bolder font size or a font emphasis color is applied.

The review provision unit 340 may display the keyword statistics 830 divided by unit period (e.g., one week, one month) or may display the same divided by various criteria, such as gender, age, and region. The review provision unit 340 may display user information (e.g., profile) on a user selecting a corresponding keyword as a keyword review for each keyword included in the keyword statistics 830. Here, when a specific user is selected, the review provision unit 340 provides an interface for verifying a review written by the specific user.

The review provision unit 340 may provide various statistical information, such as time zone distribution, gender distribution, and age distribution related to or visiting or using a corresponding place with the keyword statistics 830, through the place information screen 800.

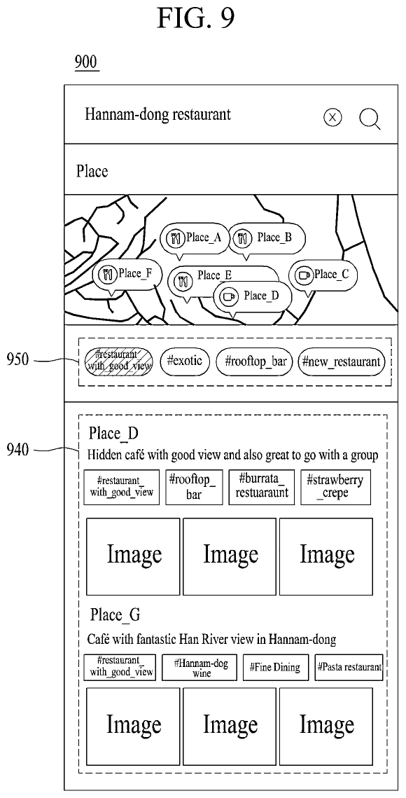

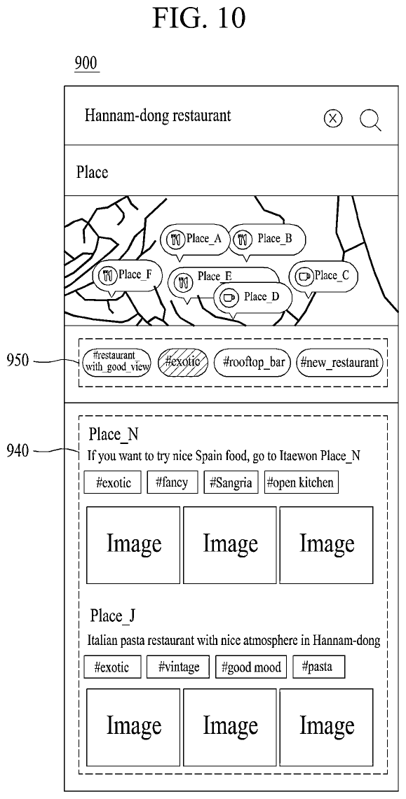

FIGS. 9 and 10 illustrate a place search process using a review keyword according to an example embodiment.

The review provision unit 340 may provide keywords that appear in keyword reviews for a place in a place search environment.

Referring to FIG. 9, in response to an input of a search keyword on a place search screen 900, the review provision unit 340 may provide a place list 940 as initial search results corresponding to the search keyword.

The review provision unit 340 may extract frequent keywords based on a predetermined criterion from keyword reviews of the corresponding place included in the initial search results and may provide the same as a search filter 950. That is, the review provision unit 340 may provide the search filter 950 using keywords that frequently appear in the keyword reviews for the corresponding place.

The review provision unit 340 may perform filtering for the initial search results based on a keyword selected from the search filter 950. For example, the review provision unit 340 may select places in which the keyword selected from the search filter 950 is registered as keyword reviews from among places included in the initial search results, as additional search results, and may provide the place list 940.

The review provision unit 340 may display a place in which the keyword selected from the search filter 950 is frequently registered as keyword reviews, at the top of the place list 940.

For example, in response to an input of search keyword <Hannam-dong restaurant>on the place search screen 900, the review provision unit 340 may provide the place list 940 corresponding to <Hannam-dong restaurant>as initial search results. Here, the review provision unit 340 may provide frequent keywords “restaurant with good view,” “exotic,” “rooftop bar,” and “new restaurant,” from keyword reviews of places included in the initial search results as the search filter 950. To provide the search filter 950, a process of converting a sentence type review keyword to a hashtag form may be included. For example, “I like the view” included in the review keyword list may be converted to “#restaurant_with_good_view” and applied to the search filter 950.

Referring to FIG. 9, when the user selects “restaurant with good view” from the search filter 950, the review provision unit 340 may select places that include the keyword “restaurant with good view” in keyword reviews from among places corresponding to <Hannam-dong restaurant> as additional search results and may provide the place list 940.

Referring to FIG. 10, when the user selects “exotic” from the search filter 950, the processor 220 may select places that include keyword “exotic” in keyword reviews from among places corresponding to <Hannam-dong restaurant> and may provide the place list 940.

That is, the review provision unit 340 may support an additional search function of finding a place having each feature as strength by providing a keyword representing features of places as the search filter 950 in the place search environment.

As described above, according to example embodiments, it is possible to replace a one-sided review environment centered on star ratings with a review environment capable of expressing qualitative information on a place by providing a review method that selects a keyword close to user experience based on visit or use from among keywords representing features of the corresponding place.

The apparatuses described herein may be implemented using hardware components, software components, and/or combination of the hardware components and the software components. For example, the apparatuses and the components described herein may be implemented using one or more general-purpose or special purpose computers or processing devices, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the example embodiments may be configured in a form of program instructions performed through various computer methods and recorded in computer-readable media. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of other media may include record media and storage media managed by an app store that distributes applications or a site that supplies and distributes other various types of software, a server, and the like.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A keyword review method executed by a computer system having at least one processor configured to execute computer-readable instructions included in a memory, the method comprising:
registering, by the at least one processor, at least one of a word, a phrase, and a sentence representing features of a place as a keyword list related to the place; and
providing, by the at least one processor, the keyword list to a user who visited or used the place and registering at least one keyword selected from the keyword list by the user as a review for the place.

2. The keyword review method of claim 1, wherein the registering as the keyword list related to the place comprises:
building a candidate keyword pool related to each business type; and
providing the candidate keyword pool corresponding to a business type of the place to an interested party of the place and registering at least one keyword selected from the candidate keyword pool as the keyword list.

3. The keyword review method of claim 1, wherein the registering as the keyword list related to the place comprises extracting a keyword related to the place in a form of at least one of a word, a phrase, and a sentence, from at least one of a document, search log data, and a text review on the Internet related to the place.

4. The keyword review method of claim 1, wherein the registering as the keyword list related to the place comprises extracting a keyword related to the place from a word dictionary that includes a word or a hashtag appearing in a document on the Internet in which the place is mentioned.

5. The keyword review method of claim 1, wherein the registering as the keyword list related to the place comprises extracting a keyword related to the place from a text review of the place based on feedback of other users on the text review of the place.

6. The keyword review method of claim 1, wherein the registering as the keyword list related to the place comprises extracting a keyword related to the place through learning using an artificial intelligence (AI) model for a keyword on a document related to the place.

7. The keyword review method of claim 2, wherein the registering as the keyword list related to the place comprises excluding at least one of a keyword representing factual information regarding the place and a keyword having negative connotation regarding the place from the candidate keyword pool.

8. The keyword review method of claim 1, wherein the registering as the review for the place comprises registering a review using the keyword list within a certain number of times based on a business type or a region of the place by the user.

9. The keyword review method of claim 1, wherein the keyword review method further comprises providing, by the at least one processor, keyword statistics on keywords registered as the review for the place.

10. The keyword review method of claim 9, wherein the providing of the keyword statistics comprises providing the keyword statistics by at least one criterion among unit period, gender, age, and region.

11. The keyword review method of claim 1, wherein the keyword review method further comprises providing, by the at least one processor, at least one keyword registered as the review for the place as a search filter for a search.

12. A non-transitory computer-readable storage medium storing a computer-implemented program for executing the keyword review method according to claim 1.

13. A computer system comprising:
at least one processor configured to execute computer-readable instructions included in a memory,
wherein the at least one processor is configured to execute:
a process of registering at least one of a word, a phrase, and a sentence representing features of a place as a keyword list related to the place; and
a process of providing the keyword list to a user who visited or used the place and registering at least one keyword selected from the keyword list by the user as a review for the place.

14. The computer system of claim 13, wherein the at least one processor is configured to execute:
a process of building a candidate keyword pool related to each business type; and
a process of providing the candidate keyword pool corresponding to a business type of the place to an interested party of the place and registering at least one keyword selected from the candidate keyword pool as the keyword list.

15. The computer system of claim 13, wherein the at least one processor is configured to execute a process of extracting a keyword related to the place in a form of at least one of a word, a phrase, and a sentence, from at least one of a document, search log data, and a text review on the Internet related to the place.

16. The computer system of claim 14, wherein the at least one processor is configured to execute a process of excluding at least one of a keyword representing factual information regarding the place and a keyword having negative connotation regarding the place from the candidate keyword pool.

17. The computer system of claim 13, wherein the at least one processor is configured to execute a process of registering a review using the keyword list within a certain number of times based on a business type or a region of the place by user.

18. The computer system of claim 13, wherein the at least one processor is configured to execute a process of providing keyword statistics on keywords registered as the review for the place.

19. The computer system of claim 18, wherein the at least one processor is configured to execute a process of providing the keyword statistics by at least one criterion among unit period, gender, age, and region.

20. The computer system of claim 13, wherein the at least one processor is configured to execute a process of providing, by the at least one processor, at least one keyword registered as the review for the place as a search filter for a search.
